(19) United States
(12) Patent Application Publication
(10) Pub. No.: US 2012/0092275 A1
(43) Pub. Date: Apr. 19, 2012

(54) INFORMATION PROCESSING APPARATUS AND PROGRAM

(75) Inventor: Katsuhiko Umetsu, Osaka (JP)

(73) Assignee: SHARP KABUSHIKI KAISHA, Osaka-shi, Osaka (JP)

(21) Appl. No.: 13/145,883

(22) PCT Filed: Jan. 22, 2010
(86) PCT No.: PCT/JP2010/050792

§ 371 Date: Sep. 9, 2011

(30) Foreign Application Priority Data
Jan. 23, 2009 (JP) 2009-012552

(51) Int. Cl. G06F 3/041

(52) U.S. Cl. 345/173

(57) ABSTRACT

In an information processing apparatus including an input detecting portion capable of detecting a plurality of touched positions simultaneously and a display portion, while a plurality of candidate images to serve as candidates are displayed as a list on the display portion and a touch is being detected by the input detecting portion, a selection image is selected based on a touched position. When the selection image is then being selected for a predetermined time or more, candidate images other than the selection image are changed to be displayed. It is thereby possible to provide an information processing apparatus or the like which is highly convenient for a user by changing a display state of candidates which are not in a selection state when selecting an item.

### TECHNICAL FIELD

The present invention relates to an information processing apparatus or the like including an input detecting portion capable of detecting a plurality of touched positions simultaneously and a display portion.

### BACKGROUND ART

Conventionally, various input methods have been proposed in an information processing apparatus. As to an input method performed by a user in an information processing apparatus, one using a key input and one using a touch panel are known. These input operations are performed in the case of selecting a function in addition to the case of inputting a text including characters and the like, and used also in a case where authentication is performed by inputting a personal identification number or the like at the time of entering or leaving a room or settlement.

For example, a method of performing a plurality of key inputs other than a method of performing a key input one by one when a user performs authentication using a key, is proposed (see, for example, Patent Literature 1). Since authentication is performed by a plurality of key operations, it is possible to enhance security strength more than performing the key input one by one.

### PRIOR ART LITERATURE

### Patent Literature

Patent Literature 1: Japanese Laid-Open Patent Publication No. 2008-152757

### SUMMARY OF INVENTION

### Problems to be Solved by the Invention

In recent years, various apparatuses have been provided as input devices. Here, there is one called a system liquid crystal display incorporating an optical sensor as one developed from a touch panel which has been previously present.

Here, brief description will be given for a system liquid crystal display incorporating an optical sensor, with use of drawings. First, outline of a system liquid crystal display D80 is shown in FIG. 19. The system liquid crystal display D80 realizes a function of a display device by a display signal and a function of an input device by a reading signal. D82 is described by enlarging the system liquid crystal display D80 in a pixel unit, where an optical sensor is incorporated for each pixel (D90) and is able to detect an operation (touch) from a user.

FIG. 20 is a cross-sectional view for one pixel of the system liquid crystal display. A protection plate D902, a glass plate D904, a color filter D906, imaging elements D908, a glass plate D910, and backlights D912 are arranged from an upper surface (a side touched by a user) of the system liquid crystal display. Additionally, in the color filter D906, a red D906R, a green D906G, and a blue D906B are arranged as RGB colors and the imaging elements are arranged for the respective colors.

First, light is emitted from the backlights 912 for displaying. The emitted light is reflected by an object (finger D84 of the user) which contacts a display surface (protection plate D902) of the system liquid crystal display. The reflected light is subjected to image processing by the imaging elements D908. Thereby contact (touch) of the object with the display surface (protection plate D902) of the system liquid crystal display is detected.

Then, since image processing is applied by an imaging element installed for each pixel, it is possible to detect a plurality of contact positions (coordinates) of objects. That is, in a previous touch panel (such as a touch panel using resistance film, a touch panel using change of electrostatic capacity, or a touch panel using electromagnetic induction and the like), one location is able to be detected as a touched position, while in a touch panel using the above-mentioned system liquid crystal display, it is possible to detect a plurality of touched positions simultaneously.

Accordingly, a conceivable usage is such that, when using a touch panel using the system liquid crystal display; displaying items to serve as candidates (candidate items) such as displayed images, numbers, characters, or symbols; and causing a user to select therefrom, a plurality of items are made to be selected.

In this case, the candidate items to be displayed are to be displayed in any positions in a normal display area (system liquid crystal display). However, there has been a problem that a candidate item which a user intends to select from among the displayed candidate items is not necessarily displayed at a position which is easily selected.

For example, consideration is given to an authentication system in which a user selects from among displayed images to be authenticated as an authorized user. In this case, the user is to select an image for authentication by a touch. Here, the user selects a plurality of images for authentication to be performed, however, there is a case where it is hard to select (hard to touch) depending on a display position of the images. Specifically, when the user touches using a forefinger and a ring finger and thereafter touches a next item, a desired item is not necessarily displayed within reach of remaining fingers. Accordingly, it has been necessary for the user to once release the touched state to make a selection again.

Additionally, also when selecting from a menu, it could not be said that a highly convenient system is provided. As an example, there is a system in which when a user selects a menu item of a parent layer, a menu of a child layer is developed and displayed.

However, the menu of the child layer is not necessarily displayed within one screen. Therefore, it is necessary to switch display of the menu of the child layer, however, it is necessary to perform a scroll operation and the like separately therefor, thus it could not be said to be an easy-to-use information processing apparatus.

In view of the above-mentioned problems, an object of the present invention is to provide an information processing apparatus or the like which is highly convenient for a user by changing a display state of candidate items not being selected in the case of selecting an item.

### Means for Solving the Problems

In view of the problem described above, an information processing apparatus of the present invention provided with an input detecting portion (for example, an input detecting portion 154 in FIG. 2) capable of detecting a plurality of touched positions simultaneously and a display portion (for example, a display portion 152 in FIG. 2) is characterized by including: a candidate item display control portion (for example, a control portion 100 in FIG. 2; step S150 in FIG. 5) for performing control of displaying a plurality of candidate items on the display portion; an item selecting portion (for example, the control portion 100 in FIG. 2; steps S152 and S154 in FIG. 5) for selecting a selection item from among the displayed candidate items based on a touched position while a touch is being detected by the input detecting portion; and a display change control portion (for example, the control portion 100 in FIG. 2; steps S156 and S158 in FIG. 5) for performing control of changing candidate items other than the selection item and displaying thereof when the selection item is being selected for a predetermined time or more by the item selecting portion.

The information processing apparatus of the present invention is characterized by further including: a candidate image storage portion (for example, a candidate image DB 142 in FIG. 2) for storing a plurality of images as the candidate images; and a correct image storage portion (for example, a correct image DB 144 in FIG. 2) for storing correct images from among the candidate images, in which the candidate item display control portion performs control of displaying a plurality of images stored in the candidate image storage portion (for example, the control portion 100 in FIG. 2; step S158 in FIG. 5); the item selecting portion selects one or a plurality of images from among the displayed candidate images as a selection image/selection images (for example, the control portion 100 in FIG. 2; step S160 in FIG. 5); and an authentication portion (for example, the authentication control portion 110 in FIG. 2; steps S166 and S168 in FIG. 5) for authenticating as an authorized user when the selection image corresponds to the correct image stored in the correct image storage portion, is further included.

The information processing apparatus of the present invention is characterized in that the authentication portion performs the authentication when a touch which is detected is released in one selection item from among the selection items selected by the item selecting portion (for example, the control portion 100 in FIG. 2; step S164 in FIG. 5).

The information processing apparatus of the present invention is characterized in that the candidate item display control portion performs control of displaying items of a parent layer from among items in a layered structure as candidate items (for example, the control portion 100 in FIG. 13; step S200 in FIG. 15); the item selecting portion includes a parent layer item selecting portion (for example, the control portion 100 in FIG. 13; step S202 in FIG. 15) for selecting a displayed item of the parent layer based on the touch detected by the input detecting portion; a child layer display control portion (for example, the control portion 100 in FIG. 13; step S204 in FIG. 15) for performing control of displaying items of a child layer which are selectable from the parent layer selected by the parent layer item selecting portion, is further included; and the display change control portion includes a child layer display change control portion (for example, the control portion 100 in FIG. 13; steps S210 and S212 in FIG. 15) for performing control of changing the items of the child layer and displaying thereof when the parent layer is being selected by the item selecting portion for a predetermined time or more.

The information processing apparatus of the present invention is characterized in that the child layer display change control portion performs control so that an item of the child layer which is not displayed on the display portion is displayed (for example, the control portion 100 in FIG. 13; step S212 in FIG. 15).

A program of the present invention is characterized by causing a computer connected to an input detecting portion (for example, the input detecting portion 154 in FIG. 2) capable of detecting a plurality of touched positions simultaneously and a display portion (for example, the display portion 152 in FIG. 2) to realize: a candidate item display controlling function (for example, the control portion 100 in FIG. 2; step S150 in FIG. 5) for performing control of displaying a plurality of candidate items on the display portion; an item selecting function (for example, the control portion 100 in FIG. 2; steps S152 and S154 in FIG. 5) for selecting a selection item from among the displayed candidate items based on a touched position while a touch is being detected by the input detecting portion; and a display change controlling function (for example, the control portion 100 in FIG. 2; steps S156 and S158 in FIG. 5) for changing candidate items other than the selection item and displaying thereof when the selection item is being selected for a predetermined time or more, by the item selecting function.

### Advantages of the Invention

According to the information processing apparatus of the present invention, when the plurality of candidate items are displayed on the display portion, the selection item is selected from among the displayed candidate items based on the detected touch and is being selected for a predetermined time or more (that is, in a case where the touch is being detected for a predetermined time or more), candidate items other than the selection item are changed and displayed. Accordingly, it becomes possible to provide a highly convenient information processing apparatus in which, since items other than one being selected are changed, when an item is selected next, the item is able to be displayed on a position which is easily selected.

Additionally, the plurality of images to be candidate items are displayed from among images stored in the candidate image storage portion, and one or a plurality of images are selected therefrom. Then, images not being selected are to be changed into different images after elapse of the predetermined time. When the selected item (image) then corresponds to an image to be a correct content, it is to be judged that authentication to be an authorized user is performed. Accordingly, in the case of performing authentication with use of an image, even when a correct image is displayed on a place where it is hard to press in a case where a user selects a plurality of candidates, with elapse of a predetermined time, a place of the image is changed and displayed on a position where it is easily touched.

Moreover, when the touch which is detected is released in one selection item from among the selection items being selected by the item selecting portion, the authentication is to be performed. Accordingly, a user is able to perform the authentication only by releasing the touch and it becomes possible to provide a highly convenient information processing apparatus.

Additionally, the items of the parent layer are displayed on the display portion, the item of the parent layer is selected based on the touch, and the items of the child layer are displayed according to the selected parent layer. When the case where the selection is then being performed for the predetermined time or more (that is, in a case where the touch is being detected for the predetermined time or more) is detected for the predetermined time or more, display of the items of the child layer is to be changed. Thereby, the parent layer is being selected by the touch and thus the display of the items of the child layer is to be changed, and it becomes possible to provide a highly convenient information processing apparatus.

Moreover, when the display of the items of the child layer is changed, it is possible to perform control so that items of the child layer which are not displayed on the display portion are displayed.

### BRIEF DESCRIPTION OF DRAWINGS

FIG. 1 are diagrams for describing external appearances of an information processing apparatus in a first embodiment.

FIG. 2 is a diagram for describing a configuration of the information processing apparatus in the first embodiment.

FIG. 3(a) is a diagram showing an example of a configuration of a candidate image DB, and (b) is a diagram showing an example of a configuration of a correct image DB.

FIG. 4 is an operation flow of correct content registration processing in the first embodiment.

FIG. 5 is an operation flow of authentication processing in the first embodiment.

FIG. 6 are diagrams for describing about an operation of selecting a candidate image in the first embodiment.

FIG. 7 is an operation flow (modification example) of authentication processing in the first embodiment.

FIG. 8 is a diagram for describing an operation example in the first embodiment.

FIG. 9 is a diagram for describing an operation example in the first embodiment.

FIG. 10 is a diagram for describing an operation example in the first embodiment.

FIG. 11 is a diagram for describing an operation example in the first embodiment.

FIG. 12 is a diagram for describing an operation example in the first embodiment.

FIG. 13 is a diagram for describing a configuration of an information processing apparatus in a second embodiment.

FIG. 14 is a diagram for describing a menu list in the second embodiment.

FIG. 15 is an operation flow of menu display processing in the second embodiment.

FIG. 16 is a diagram for describing an operation example in the second embodiment.

FIG. 17 is a diagram for describing an operation example in the second embodiment.

FIG. 18 is a diagram for describing an operation example in the second embodiment.

FIG. 19 is a diagram for describing about a principle of the system liquid crystal display.

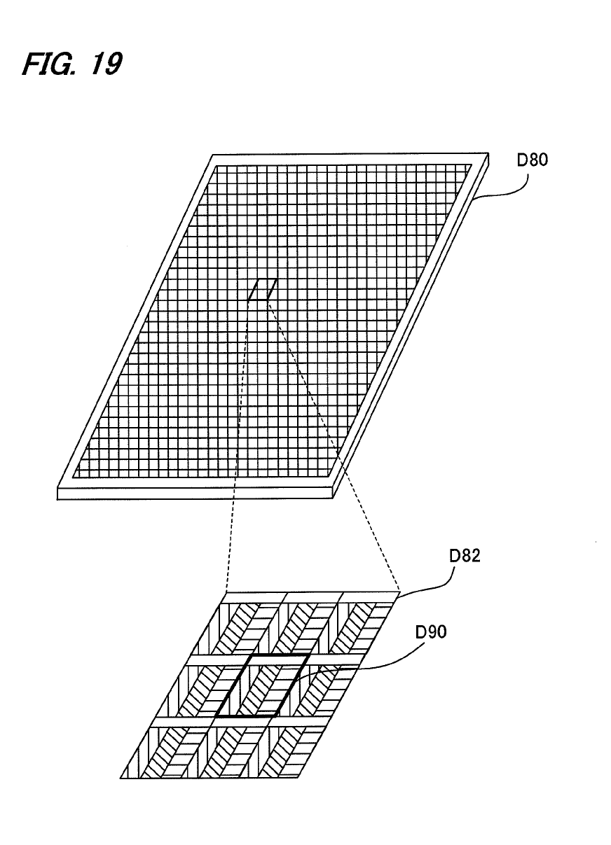

FIG. 20 is a diagram for describing about a principle of the system liquid crystal display.

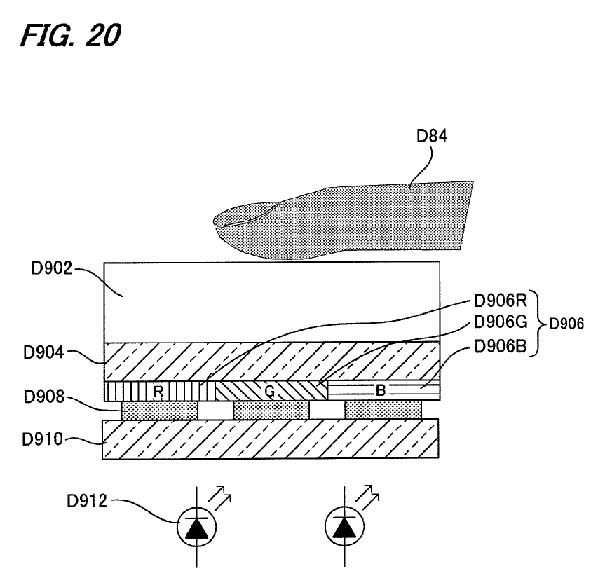

### MODES FOR CARRYING OUT THE INVENTION

Hereinafter, description will be given for embodiments of the present invention with reference to accompanying drawings to help the present invention to be understood. Note that, the following embodiments are examples of specifying the present invention and not characterized as limiting the technical scope of the present invention.

### EMBODIMENTS

### 1. First Embodiment

First, description will be given for a first embodiment. In the first embodiment, description will be given for a case where the present invention is applied to an authentication system using an image as an item to be selected when a user is authenticated to be an authorized user. That is, first, candidate images are displayed as candidate items. Then, a selection image is to be selected as a selection item from among the candidate images. Hereinafter, description will be given in detail with use of drawings.

[1.1 Apparatus Configuration]

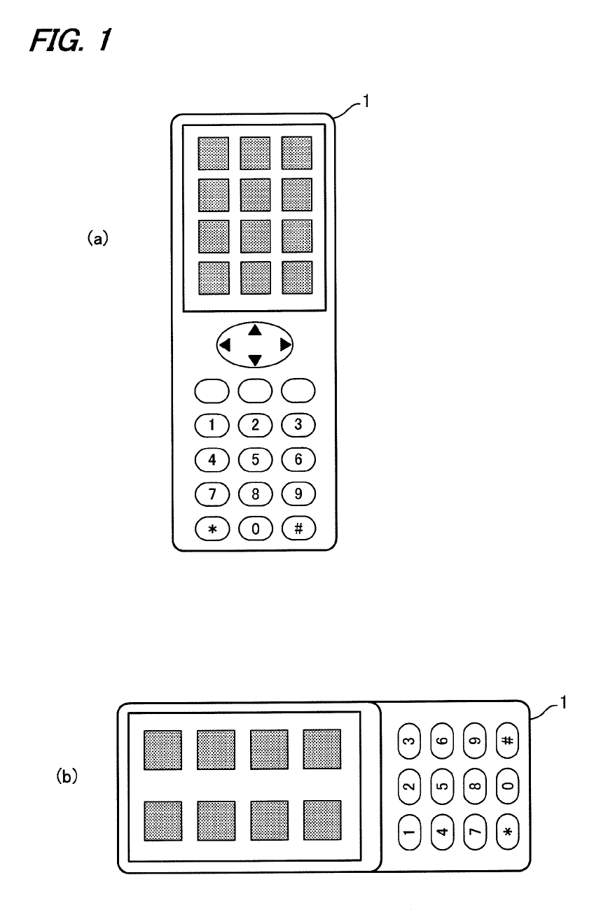

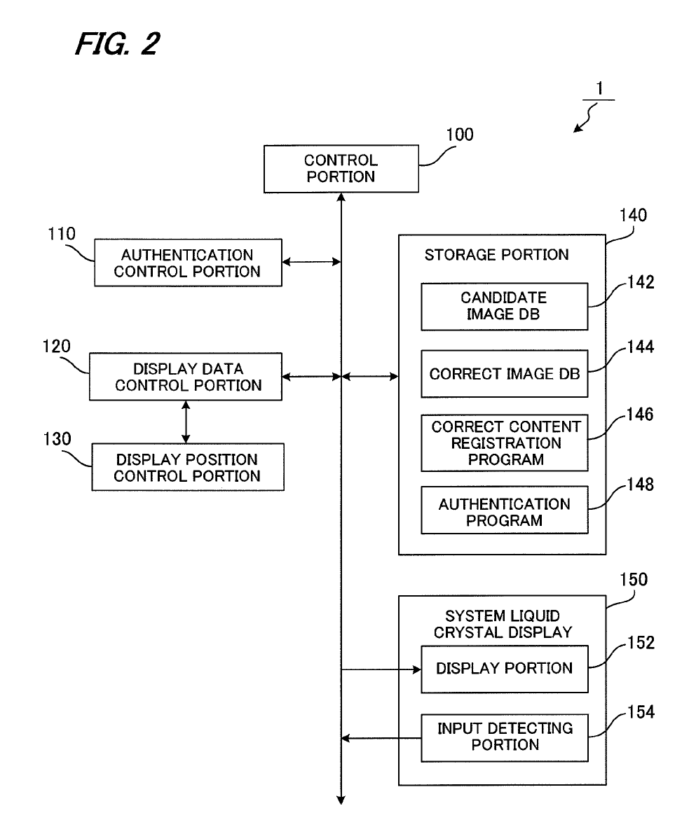

First, an apparatus overview of an information processing apparatus 1 to which the present invention is applied is shown. In the present embodiment, a case of applying to a mobile phone as an example of the information processing apparatus 1 is described. For example, FIG. 1(a) is a case where a display screen of a mobile phone is vertical display and FIG. 1(b) is a diagram showing an example of a case where a display screen is horizontal display. Then, FIG. 2 shows a function configuration of the information processing apparatus 1. In the information processing apparatus 1, an authentication control portion 110, a display data control portion 120, a storage portion 140, a system liquid crystal display 150 are connected to a control portion 100 via a bus. Additionally, a display position control portion 130 is connected to a display data control portion 120.

The control portion 100 is a function portion for controlling an operation of the information processing apparatus 1, and is comprised of a control circuit such as a CPU required for the information processing apparatus 1. The control portion 100 is to realize various processing by reading out and executing various programs stored in the storage portion 140.

The authentication control portion 110 is a function portion for performing authentication control to authenticate whether or not a user is an authorized user by judging whether or not an image selected by the user corresponds to an image stored in a correct image DB 144 which will be described below. The information processing apparatus executes various processing according to a result of the authentication. For example, in a case where the information processing apparatus 1 is used for control of entering or leaving a room, when authentication is performed properly, entering or leaving the room is to be permitted. Moreover, in a case where the information processing apparatus 1 is used in settlement processing, when authentication is performed properly, the settlement processing is to be executed.

The display data control portion 120 is a function portion for controlling data to be displayed on the system liquid crystal display 150 (display portion 152) which will be described below, based on instructions of the control portion 100. The display data control portion displays an image to be displayed on the control portion 100 and displays at a display position based on the display position control portion 130.

The display position control portion 130 is a function portion for determining a display position of an image to be displayed (candidate image, for example) and controlling the display data control portion 120. A content of a display signal to be output to the display portion 152 is to be specifically controlled by the display data control portion 120. Then, the display data control portion 120 is to perform the output to the display portion 152 based on a control signal which is input from the display position control portion 130.

The storage portion 140 is a function portion for storing various data and programs for making the information processing apparatus 1 operate. The control portion 100 is to realize various functions by reading out and executing the programs stored in the storage portion 140.

Here, in the storage portion 140, a candidate image DB 142, the correct image DB 144, a correct content registration program 146, and an authentication program 148 are stored.

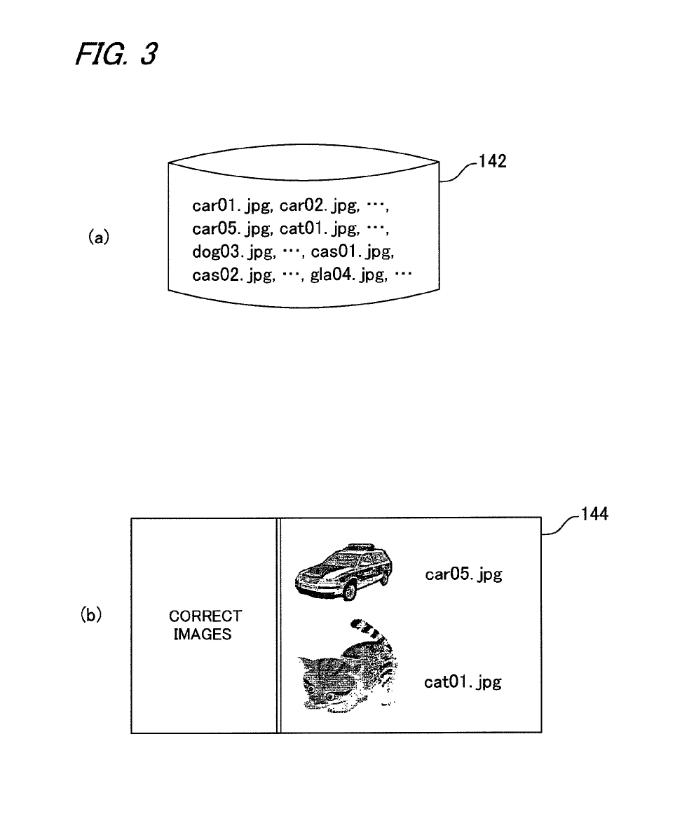

As shown in FIG. 3(a), the candidate image DB 142 is a DB in which images to be displayed as candidates to be selected (candidate images) at the time of authentication are stored. In the present embodiment, it is assumed that the candidate images are stored in a JPEG format as an example, but other image formats are also available as a matter of course.

The correct image DB 144 is a DB in which correct images for authentication are registered by a user. As shown in FIG. 3(b), images to be a correct content are registered in the correct image DB 144. Note that, these correct images are ones selected from among the candidate images stored in the candidate image DB 142.

The system liquid crystal display 150 is a display device including the display portion 152 and an input detecting portion 154. A detailed operation is described above, and the display portion 152 is comprised of a liquid crystal display, for example, and displays various information based on a display control signal of the display data control portion 120. Additionally, the input detecting portion 154 is comprised of a touch panel capable of detecting a plurality of touched positions simultaneously and detects coordinates of locations touched by a user.

[1.2 Flow of Processing]

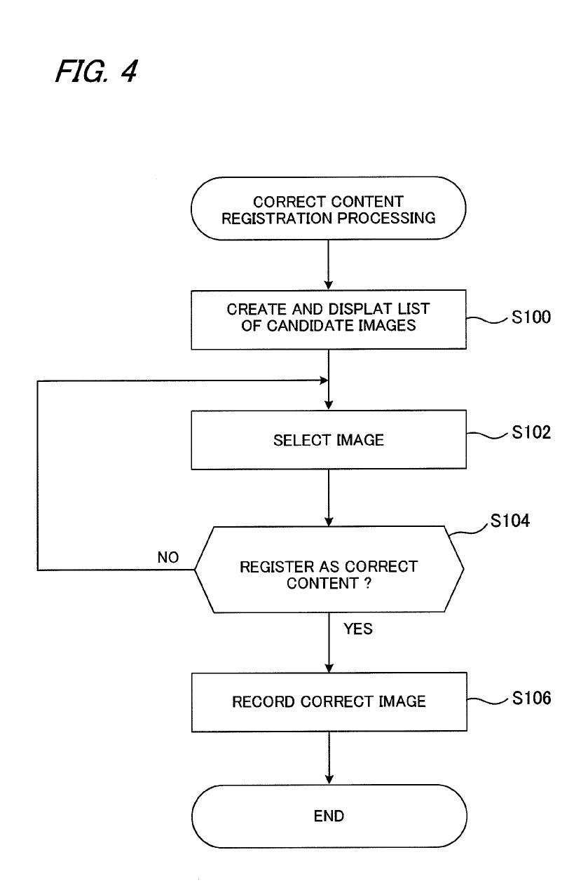

Next, description will be given for a flow of processing in the present embodiment. First, description will be given for correct content registration processing in which correct images are registered based on FIG. 4. Here, the correct content registration processing is processing which is realized by the control portion 100 by reading out and executing the correct content registration program 146 stored in the storage portion 140.

First, candidate images are read out from the candidate image DB 142 to create and display an image list (step S100). Here, a correct image to serve as a correct content is selected by a user (step S102). Note that, one or more correct images may be selected here.

When an operation in which the image is selected and registered as the correct image is then performed (step S104; Yes), the image is registered in the correct image DB 144 as the correct image (step S106).

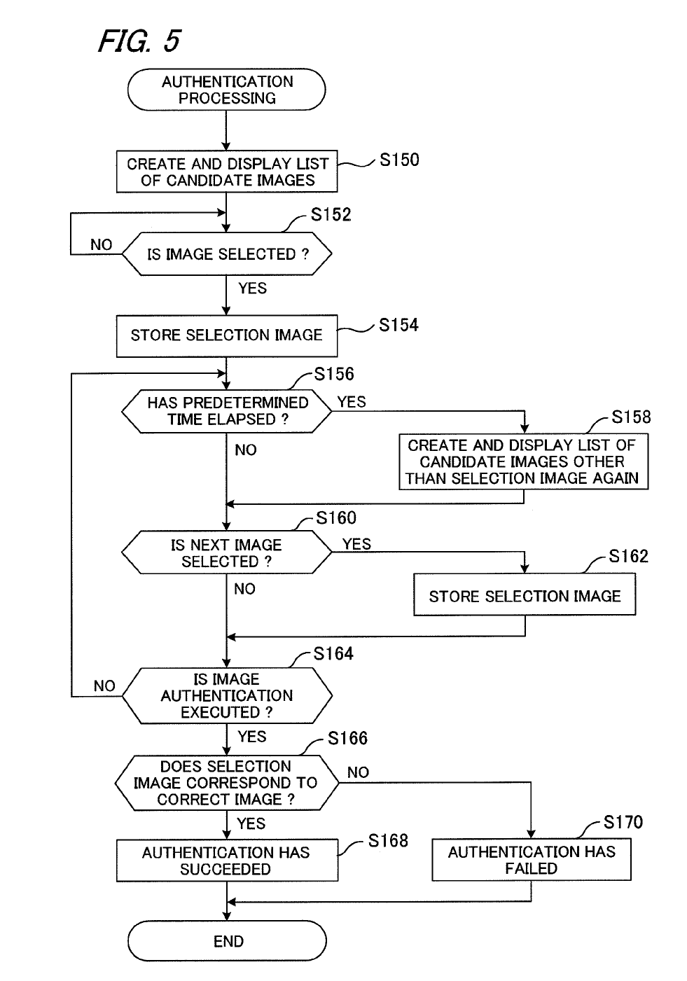

Next, description will be given for authentication processing based on FIG. 5. Here, authentication processing is processing which is realized by the control portion 100 by reading out and executing the authentication program 148 stored in the storage portion 140.

First, the control portion 100 creates and displays a list of candidate images at random from the candidate image DB 142 (step S150). Here, the number of candidate images to be displayed may be any of the predetermined number, the number set by a user, and the number determined in view of a display area of the display portion 152. Note that, description will be given in the present embodiment assuming that nine candidate images are displayed.

When one of any candidate images is then selected by the user (step S152; Yes), the selected image is temporarily stored as a selection image (step S154).

Here, as a method of selecting from candidate images, the input detecting portion 154 detects a touch and judges which candidate image is selected based on the detected position.

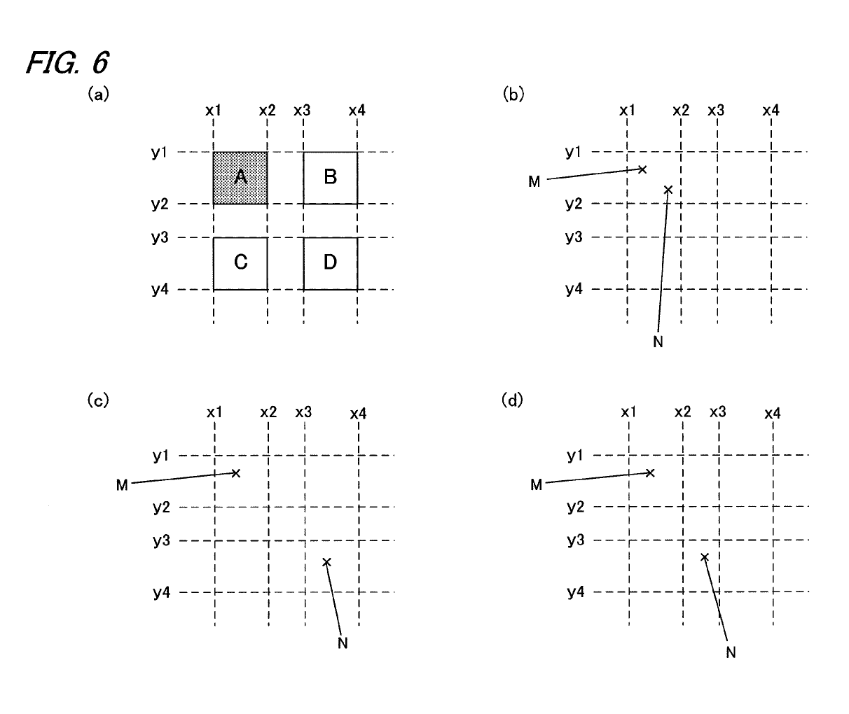

Here, description will be given for selection from candidate images with use of FIG. 6. As shown in FIG. 6(a), it is assumed that

image A<(x1, y1)-(x2, y2)>

image B<(x3, y1)-(x4, y2)>

image C<(x1, y3)-(x2, y4)>

image D<(x3, y3)-(x4, y4)>

are displayed.

For example, it is assumed that touches of two points of a point M and a point N are detected by the input detecting portion 154, and the points are represented by a coordinate M (Xm, Ym) and a coordinate N (Xn, Yn). When the coordinate of the point M is at a position of x1<Xm<x2, y1<Ym<y2, the point M is in an area of the image A which is displayed in an area of (x1, y1)-(x2, y2), and therefore an item selecting portion judges that the image A is selected. Coordinates in areas corresponding to the respective display images in this case are stored in the display position control portion 130. Similarly, when the coordinate of the point N is at a position of x1<Xn<x2, y1<Yn<y2, the point N is also in the area of the image A, therefore the item selecting portion judges that the image A is selected. In this case, touches of the two points of the point M and the point N are detected, but an image which is selected by the item selecting portion is to be only the image A (FIG. 6(b)).

However, when a coordinate of the point N is at a position of x3<Xn<x4, y3<Yn<y4, the point N is in the area of the image D which is displayed in an area of (x3, y3)-(x4, y4), and therefore the control portion 100 judges that the image D is selected. In this case, touches of the two points of the point M and the point N are detected and images to be selected are the image A and the image D. In this way, even when a plurality of touches are detected simultaneously, only the image A is selected in the former while a plurality of images of the image A and the image D are selected in the latter (FIG. 6(c)).

Note that, when a detected coordinate is out of ranges of any images, selection of an image is not performed. For example, when a coordinate of the point N is at a position of x2<Xn<x3, y3<Yn<y4, an image is not selected by the point N, and only an image selected by the point M is to be a selection image (FIG. 6(d)).

Then, the selected image is stored as a selection image. Note that, decoration display (for example, inverting a selection image, displaying by surrounding with a frame line, displaying by blinking) or the like showing that an image is selected may be applied.

Then, in a case where a predetermined time has elapsed in a state where a selection image remains to be selected, that is, a candidate image is being touched continuously (touch is kept being detected) (step S156; Yes), a list of candidate images other than the selection image is created again and displayed again (step S158). Note that, in the present embodiment, a case is stated where the list is created again in a case where a predetermined time has elapsed irrespective of a selected selection image, however, processing may be added in which creation of the list is performed again when the selected selection image is a preset specific image while creation of the list is not performed again in the case that the selected selection image is an image other than the preset specific image. Additionally, to the contrary, processing may be such that creation of the list is not performed again when the selected selection image is the preset specific image while creation of the list is performed again in the case that the selected selection image is an image other than the preset specific image. Further, in the above description, although presence/absence of creating the list again is judged by an image as a key, which may be a position being selected instead of the image.

For example, when nine images are displayed from among candidate images and one is selected as a selection image, candidate images for eight images other than the selection image are read out again from the candidate image DB 142 to create display of the list again and display it.

Note that, a candidate image which is currently displayed and a candidate image displayed again may always be different images, or such restriction may not be set. Additionally, restriction may be set so that the same image is not displayed on the same position in displaying again. As to these display methods, it becomes possible to enhance security strength by tightening restriction and to improve convenience by reducing restriction.

Next, it is determined whether or not a next image is further selected from among next candidate images (step S160). When the next image is selected (step S160; Yes), the next selected image is also stored as a selection image (step S162).

Here, whether or not image authentication is executed by the user is determined (step S164). Here, when an operation of performing image authentication is conducted by the user, the process goes to step S166 (step S164; Yes→step S166), when the operation of performing image authentication is not performed, processing is executed repeatedly from step S156 (step S164; No→step S156).

Here, various methods are conceivable as an operation for performing image authentication. The methods are, for example, a case where it is determined as a trigger for performing image authentication that a selection state of a selection image has been released (that is, whether or not a touch on the input detecting portion 154 is being continued (when a user touches with his/her finger, whether or not there is a released finger) is determined), a case where it is determined as a trigger for performing image authentication that an authentication button is selected by a user, or the like.

Then, when the image authentication is performed, whether or not current selection images correspond to correct images which are registered in the correct image DB 144 is judged (step S166). Here, when the selection images correspond to the correct images, it is determined that authentication has succeeded (step S166; Yes→step S168). On the other hand, when the selection images do not correspond to the correct images, it is determined that authentication has failed (step S166; No→step S170).

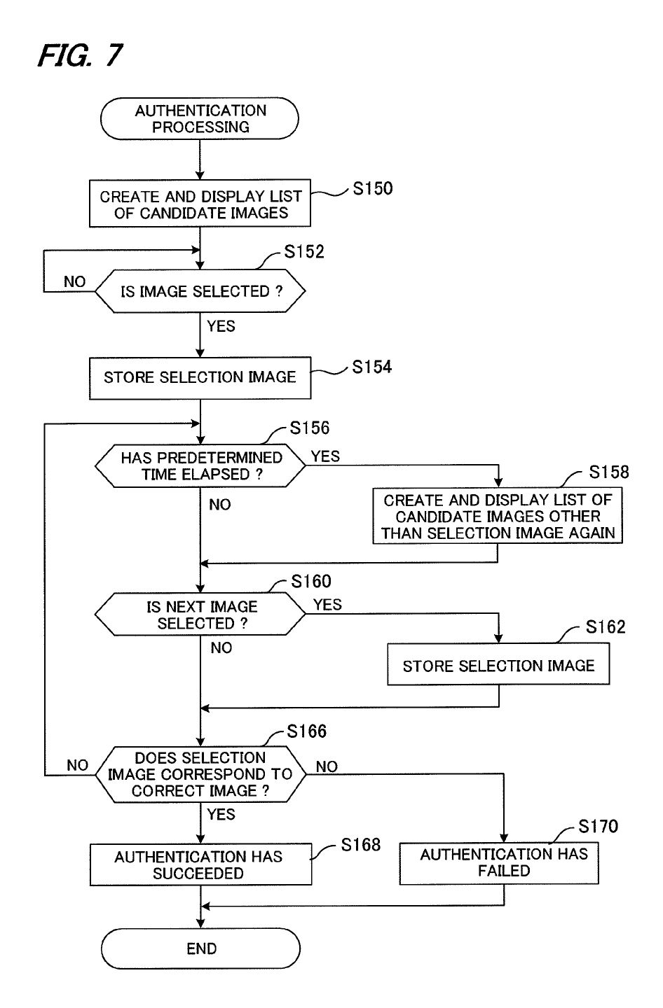

Note that, a trigger for the operation of performing image authentication at step S164 may be such that authentication is performed automatically when the selection images correspond to the correct images, for example. An operation flow in this case is shown in FIG. 7.

That is, without executing step S164, whether or not selection images currently being selected correspond to correct images is determined at step S166. A case where the selection images correspond to the correct images is determined as success of authentication (step S166; Yes→step S168), and in the case that the selection images do not correspond to the correct images, processing is executed repeatedly from step S156. This makes it possible for the user to execute authentication processing without awareness of an operation such as “executing authentication”.

[1.3 Operation Example]

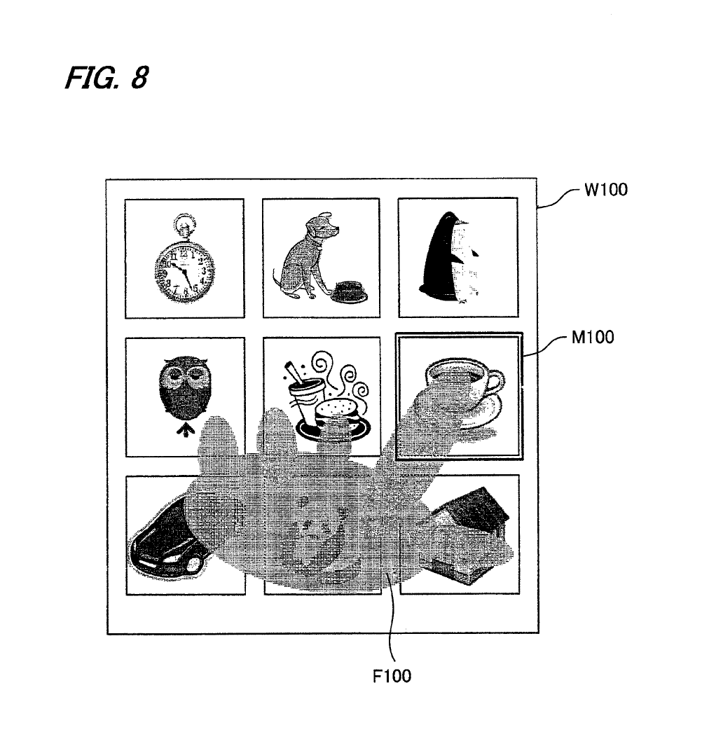

Next, description will be given for an operation example of the present embodiment. FIG. 8 is a diagram for describing an example of a display screen W100 displayed on the system liquid crystal display 150.

On the display screen W100, nine candidate images are read out from the candidate image DB 142 and displayed as a list (step S150 in FIG. 5). When a correct image to be used for authentication is not displayed, a user selects any one image (step S152; Yes→step S154). In the figure, an image M100 is selected (touched) by a user F100 as a selection image. Note that, in this case, the image M100 is touched with a forefinger of the user.

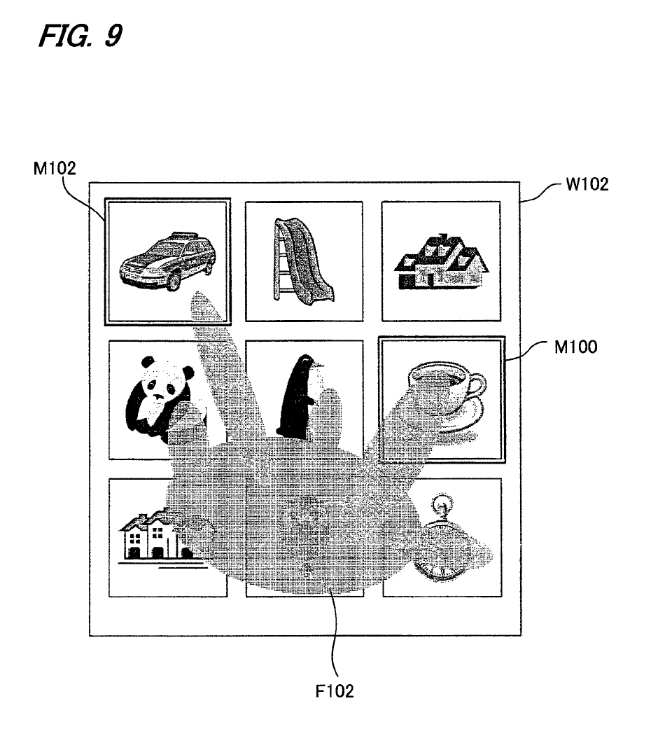

After elapse of a predetermined time in a state of FIG. 8 (step S156; Yes), candidate images other than the image M100 which is being selected are updated to be displayed (step S158). FIG. 9 is an example of a display screen W102 when candidate images other than the image M100 are updated and displayed. Here, a user F102 further selects an image M102 which is a correct image (step S160; Yes→step S162). Here, selection is made for the image M100 with the forefinger of the user and for the image M102 with a ring finger of the user.

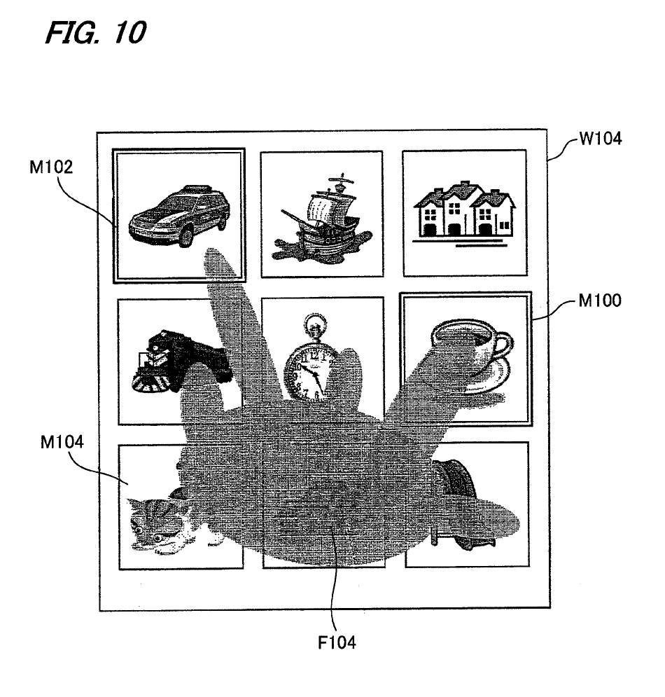

After elapse of a predetermined time in a state of FIG. 9, candidate images other than the image M100 and the image M102 which are being selected are updated to be displayed (step S158). FIG. 10 is an example of a display screen W104 in a case where images other than the image M100 and the image M102 are updated and displayed. Here, an image M104 to be a correct image is displayed on the display screen W104. Here, the user tries to select the image M104, however, decides to wait until after a predetermined time elapses since it is hard to select with a current display position thereof.

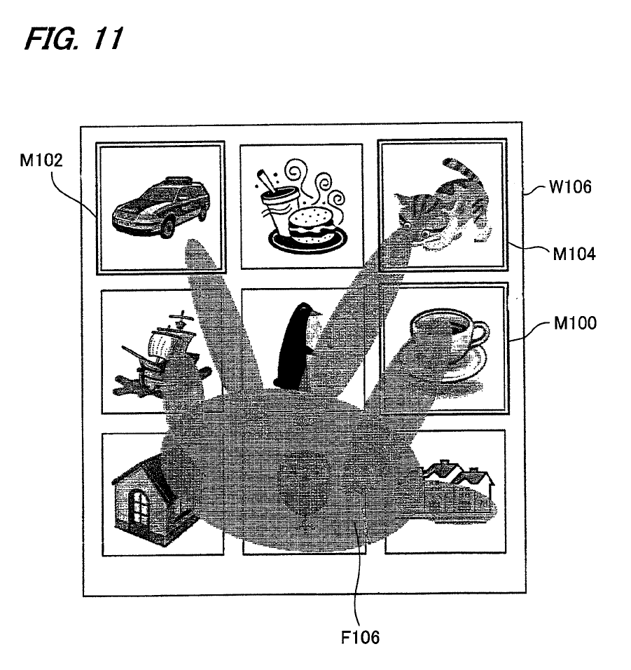

After elapse of a predetermined time in a state of FIG. 10, candidate images other than the image M100 and the image M102 which are being selected are updated to be displayed (step S156; Yes→step S158). FIG. 11 is an example of a display screen W106 when candidate images other than the image M100 and the image M102 are updated and displayed. In the display screen W106, the image M104 is displayed on a location which is easily selected by a user F106. Then, the user F106 further selects an image M106 which is a correct image (step S160; Yes→step S162). Here, selection is made for the image M100 with a forefinger of a user, for the image M102 with a ring finger of the user, and for the image M104 with a middle finger of the user.

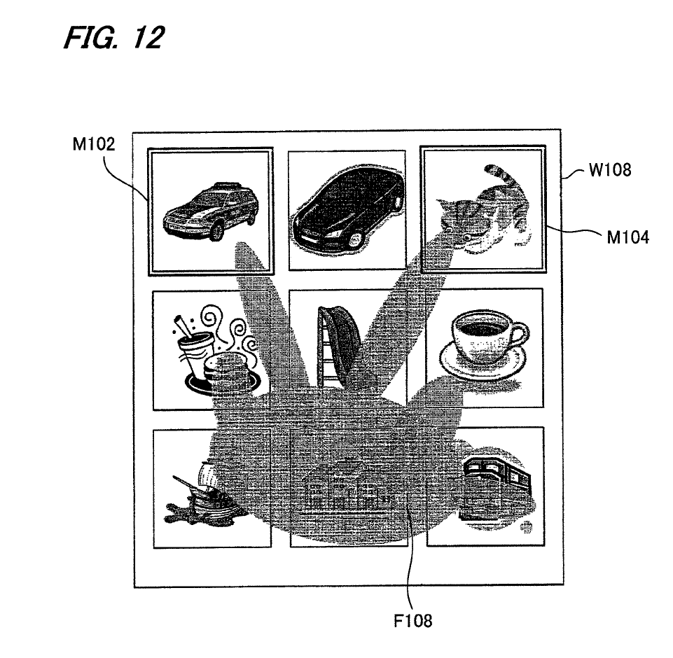

All correct images are selected in a state of FIG. 11, therefore the user releases the selection state of the image M100 which is not the correct image (step S164; Yes). FIG. 12 is a diagram showing an example of a display screen W108 in a case where the selection state of the image M100 is released in FIG. 11.

Since the selection state of the image is released, the authentication control portion 110 verifies the selection images which are currently selected with the correct image DB 144 (step S166). When the selection images correspond to correct images, it is determined that authentication has been succeeded (step S166; Yes→step S168).

In this way, according to the present embodiment, when a user selects a plurality of images (items), for each elapse of a predetermined time, display positions and contents of images other than the images being selected are to change. This makes it possible for a user to select an image naturally without taking an awkward way of pressing when selecting an image (item) and to realize a highly convenient authentication system.

Note that, although description has been given for an example of using images as candidate items with respect to the embodiment described above, authentication may be performed by displaying other items such as numbers, characters, graphics, symbols, photographs, and colors and selecting from the items as a matter of course.

Additionally, regarding the embodiment as described above, although description has been given assuming that the list of candidate images are created again at a timing after elapse of a predetermined time, images may be changed at other timing. For example, at step S160, a list of candidate images other than selection images may be created again at a timing when a next image is selected, and a user may give instructions to create the list of candidate images again at arbitrary timing.

Moreover, regarding the embodiment as described above, although description has been given assuming that the list of candidate images, in the case of being created again, is read out from the candidate image DB 142 to be displayed, for example, kinds of images once displayed as a list of candidate images may keep as is and positions thereof may be changed. In this case, an expected advantage is such that a small number of steps which are selected by a user are enough since images being displayed are not changed.

Further, in addition to the embodiment described above, as to a position of an image and an image to be displayed, for example, in a case where a predetermined time has elapsed, candidate images are newly read out from the candidate image DB 142 to display a list of the candidate images. Then, in a case where an image is selected, control may be performed such that only the positions of the candidate images being displayed are moved. In this way, various methods are conceivable as to a method of displaying a list of candidate images.

Note that, regarding the embodiment as described above, although description has been given for an example of performing authentication by releasing a selection image, for example, authentication may be performed such that an authentication button is displayed on the same display portion as that of the images other than the button, to be selected. Additionally, authentication may be performed by arranging the authentication button on a front surface, a side surface, a rear surface or the like instead of displaying on the display portion, to be pressed. In particular, the case of arranging on the side surface or the rear surface makes it difficult for a third party to visually confirm that the selection screen and the authentication button are pressed simultaneously.

Additionally, regarding the embodiment as described above, although description has been given for an example of authentication, for example, it may be used for selection from a menu or input of a number or the like. That is, the scope of applying the present invention may be such that it is enough as long as, in an information processing apparatus capable of detecting a plurality of touched positions simultaneously, while an item displayed on the information processing apparatus is kept being pressed, display of another items is updated.

### 2. Second Embodiment

Next, description will be given for a second embodiment. In the second embodiment, description will be given by taking an example of a case of selecting items from menu items as items to be selected by a user. That is, first, menu items of a first layer are displayed as items of a parent layer. Then, according to the selection on the first layer, menu items of a second layer serving as items of a child layer are to be displayed.

Hereinafter, description will be given in detail with use of drawings.

[2.1 Apparatus Configuration]

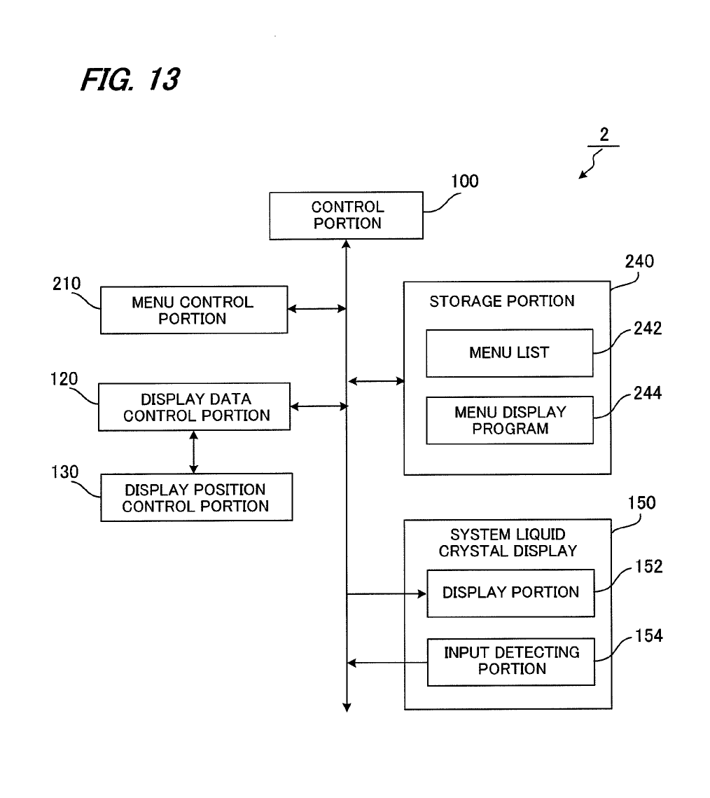

A configuration of an information processing apparatus 2 to which the present invention is applied is shown in FIG. 13. The information processing apparatus 2 is configured by including the control portion 100, a menu control portion 210, the display data control portion 120, the display position control portion 130, a storage portion 240, and the system liquid crystal display 150 (display portion 152 and input detecting portion 154). Note that, same numerals are given to ones which are the same as the components described in the first embodiment, and description thereof will be omitted.

The menu control portion 210 is a control portion for performing control of switching a menu to be displayed, update instructions, and the like. Control is performed for reading out menu items to be required from a menu list 242 which will be described below to display a menu screen.

The storage portion 240 is a function portion for storing various data and programs for making the information processing apparatus 2 operate. The control portion 100 is to realize various functions by reading out and executing the programs stored in the storage portion 240. Here, the storage portion 240 stores the menu list 242 and a menu display program 244.

The menu list 242 is a list in which a menu item (for example, “Web”) in the information processing apparatus 2 is stored in association with an item number (for example, “A”). Here, “A”, “B”, “C”, “D” or the like indicates a menu in the first layer (parent layer). Additionally, menus of the second layer (child layer) corresponding to the first layer (parent layer) are also stored, respectively. For example, “B-1” is a menu of a child layer having “B” as a parent layer.

[2.2 Flow of Processing]

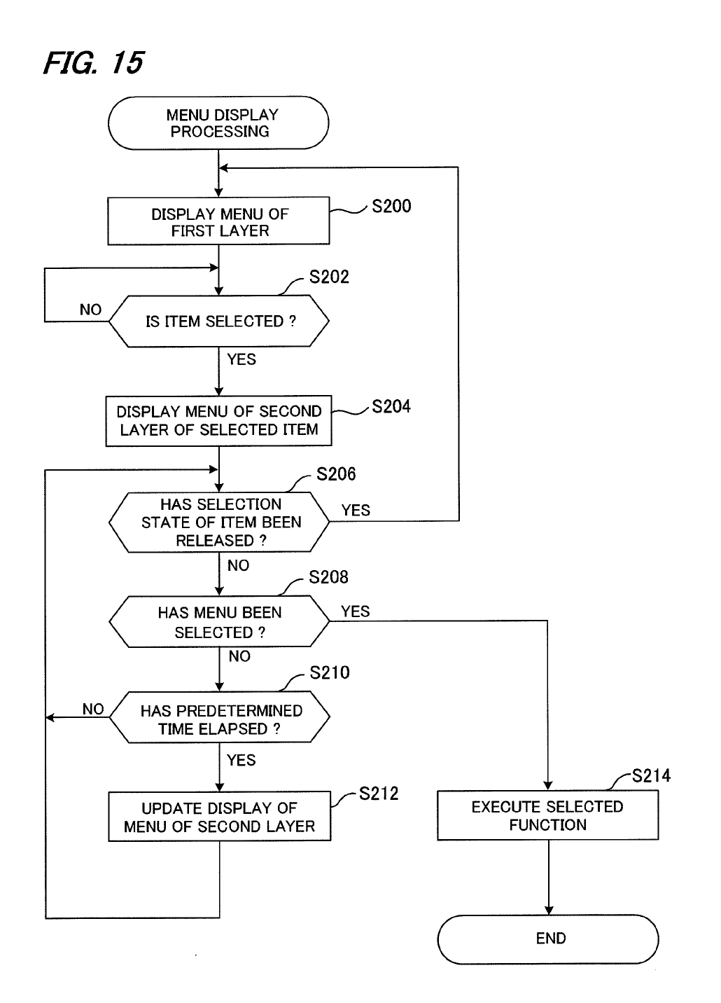

Next, description will be given for menu display processing which is processing in the second embodiment with use of FIG. 15. The menu display processing is processing realized by the control portion 100 by reading out and executing the menu display program 244 stored in the storage portion 240.

First, the display data control portion 120 displays a menu of the first layer (step S200). Then, a menu item is selected from the displayed first layer (step S202).

When a menu item is selected by a user (step S202; Yes), a lower level menu (second layer) of the selected menu item is displayed (step S204). Here, when selection of the menu item of the first layer is released, processing is executed again from step S200 to go back to menu display of the first layer (step S206; Yes, step S200).

When a predetermined time has elapsed without selecting a menu item of the second layer in a state where a menu of the second layer is displayed (step S206; No→step S208; No→step S210; Yes), display of the menu items of the second layer is updated (step S212).

On the other hand, when a menu item of the second layer is selected in the state where the menu of the second layer is displayed, the selected function is executed (step S206; No→step S208; Yes→step S214).

[2.3 Operation Example]

Next, description will be given for an operation example in the second embodiment with use of drawings.

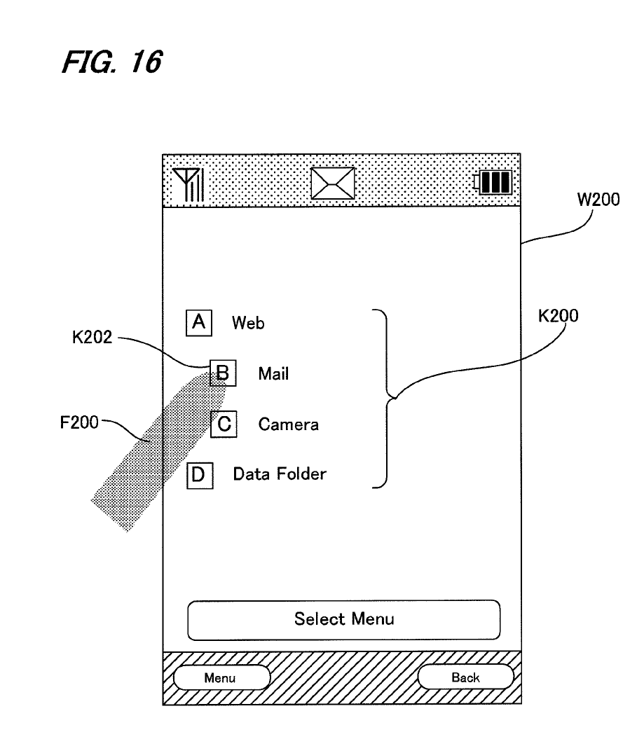

FIG. 16 is a diagram showing an example of a display screen W200 for displaying the first layer (parent layer). In the display screen W200, menu items K200 of the first layer are displayed (step S200 in FIG. 15). Here, a user F200 touches a menu item K202 “B Mail” to make a selection state (step S202; Yes). Note that, a method of touching by the user F200 may be, for example, touching by hand (with finger) or touching with a stylus.

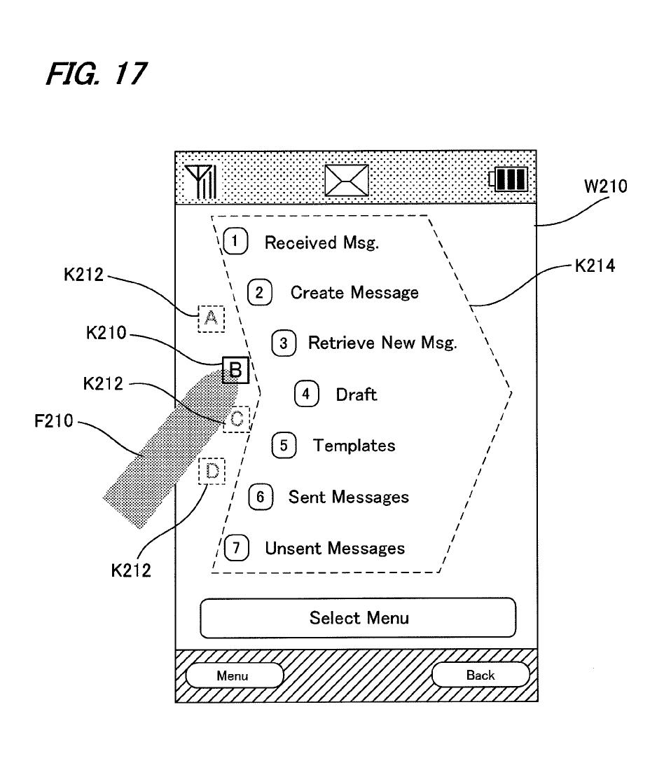

A screen to be shifted when the menu item K202 is selected in a state of FIG. 16 is a display screen W210 of FIG. 17. In the display screen W210, a menu item K210 of the first layer (parent layer) is in a selection state by a user F210. Here, in the first layer (parent layer), a menu item K212 which is not selected is displayed faintly.

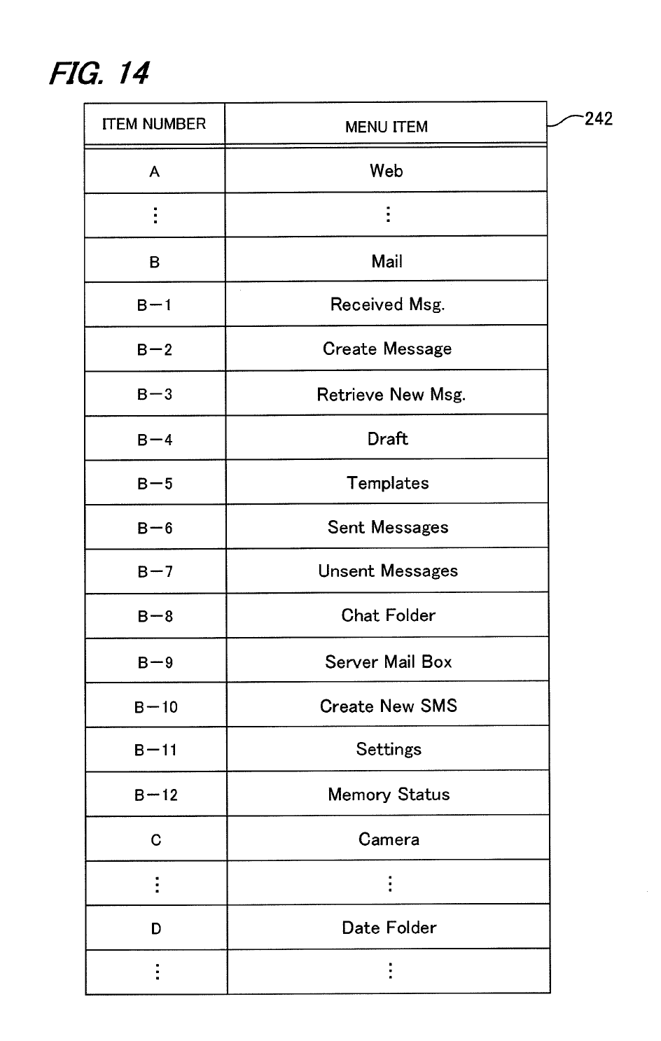

Moreover, in the center of the screen, a menu item K214 of the second layer (child layer) associated with the menu item K212 being selected is displayed (step S204). Here, in a menu of the second layer corresponding to the menu item K210 “B Mail”, there are twelve menu items with reference to the menu list 242 as shown in FIG. 14. However, it is possible to display only seven menu items on the display screen W210. Therefore, menu items of an item number “B-1” to “B-7” are displayed on the display screen W210 while menu items of “B-8” to “B-12” are not displayed.

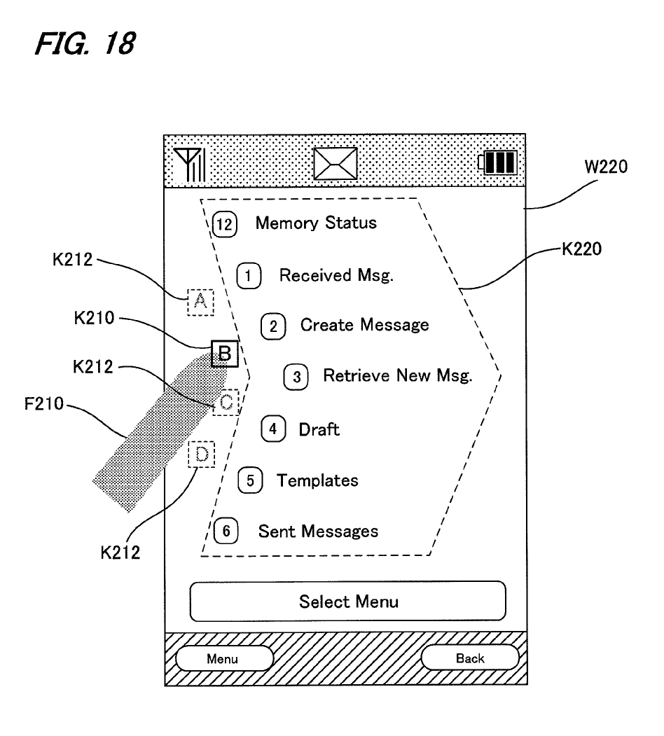

A screen to be shifted in a case where a predetermined time has elapsed with a selection state of the menu item K210 in a state of FIG. 17 is a display screen W220 of FIG. 18. Due to elapse of a predetermined time, the menu control portion 210 updates menu display of the second layer (step S210; Yes→step S212). That is, “B-12” which has not been displayed on the display screen W210 is displayed, and “B-7” is not displayed instead.

In this way, for each elapse of a predetermined time while the menu item K210 is kept in a selection state, display of a menu item K220 of the second layer is to be updated and displayed.

Note that, various methods are conceivable as a method of updating display of a menu. For example, after elapse of a predetermined time with a selection state on the display screen W210 of FIG. 17, the menu items “B-8” to “B-12” which are not displayed may be switched and displayed. Moreover, by displaying “B-1” and “B-2” in succession to the “B-8” to “B-12”, menu items of the second layer may be displayed in succession.

Additionally, the menu control portion 210 may apply a visual effect in the case of switching and displaying menu display of the second layer. For example, in the case of switching the display of the menu items of the second layer, by applying an effect such as performing rotation display with the menu item K210 of the first layer as the center, it becomes possible for a user to perform an intuitive operation.

Moreover, in the present embodiment, description has been given assuming that a menu list is stored and menu display is performed based on the menu list, but methods are not limited to the methods described above. That is, description may be that menu selection processing is performed directly in a program (processing).

Additionally, for convenience of description, description has been given assuming that there are two menu layers of the first layer (parent layer) and the second layer (child layer) as the menu layer, however, there may be three or more layers as a matter of course.

In this way, according to the present embodiment, even when it is impossible to display all of menu items on a display screen, it is possible to switch display of menu items according to a state of a touch by a user. Accordingly, it becomes possible for a user to select a desired menu easily since a menu is displayed with an easier operation.

### 3. Modification Example

As above, description has been given in detail for embodiments of the present invention with reference to drawings, however, a specific configuration is not limited to the embodiments, and design or the like in a range not departing from the spirit of this invention is also included in the scope of claims.

Additionally, description has been given assuming that the system liquid crystal display is used in the embodiments described above, however, with an apparatus which is similar thereto, it is realizable as a matter of course. Further, description has been given assuming that the display portion 152 and the input detecting portion 154 are integrated with the information processing apparatus 1 and the information processing apparatus 2, however, may also be ones connected thereto as external devices.

### DESCRIPTION OF REFERENCE NUMERALS

1, 2 information processing apparatus
100 control portion
110 authentication control portion
120 display data control portion
130 display position control portion
140 storage portion
   142 candidate image DB
   144 correct image DB
   146 correct content registration program
   148 authentication program
150 system liquid crystal display
   152 display portion
   154 input detecting portion
210 menu control portion
240 storage portion
   242 menu list
   244 menu display program

1.-6. (canceled)

7. An information processing apparatus including an input detecting portion capable of detecting a plurality of touched positions simultaneously and a display portion, comprising:
a candidate item display control portion for performing control of creating at random and displaying a plurality of candidate items on the display portion;
an item selecting portion for selecting a selection item from among the displayed candidate items based on a touched position while a touch is being detected by the input detecting portion; and
a display change control portion for performing control of changing candidate items other than the selection item and displaying thereof when the selection item is being selected for a predetermined time or more by the item selecting portion.

8. The information processing apparatus according to claim 7, further comprising:
a candidate image storage portion for storing a plurality of images as the candidate items; and
a correct image storage portion for storing correct images from among the candidate images, wherein
the candidate item display control portion performs control of displaying a plurality of images stored in the candidate image storage portion;
the item selecting portion selects one or a plurality of images from among the displayed candidate images, as a selection image/selection images, and an authentication portion for authenticating as an authorized user when the selection image corresponds to the correct image stored in the correct image storage portion, is further included.

9. The information processing apparatus according to claim 8, wherein the authentication portion performs the authentication when a touch which is detected is released in one selection item from among the selection items selected by the item selecting portion.

10. An information processing apparatus including an input detecting portion capable of detecting a plurality of touched positions simultaneously and a display portion, comprising:
a candidate item display control portion for performing control of displaying a plurality of candidate items on the display portion;
an item selecting portion for selecting a selection item from among the displayed candidate items based on a touched position while a touch is being detected by the input detecting portion; and
a display change control portion for performing control of changing candidate items other than the selection item and displaying thereof when the selection item is being selected for a predetermined time or more by the item selecting portion,
wherein
the candidate item display control portion performs control of displaying items of a parent layer from among items in a layered structure, as candidate items,
the item selecting portion includes a parent layer item selecting portion for selecting a displayed items of the parent layer based on the touch detected by the input detecting portion,
a child layer display control portion for performing control of displaying items of a child layer which are selectable from the parent layer selected by the parent layer item selecting portion as the items of the parent layer remain to be displayed to be selectable, is further included; and
the display change control portion includes a child layer display change control portion for performing control of changing the items of the child layer and displaying thereof when the parent layer is being selected by the item selecting portion for a predetermined time or more.

11. The information processing apparatus according to claim 10, wherein the child layer display change control portion performs control so that an item of the child layer which is not displayed on the display portion is displayed.

12. A program for causing a computer provided with an input detecting portion capable of detecting a plurality of touched positions simultaneously and a display portion to realize:
a candidate item display controlling function for performing control of creating at random and displaying a plurality of candidate items on the display portion;
an item selecting function for selecting a selection item from among the displayed candidate items based on a touched position while a touch is being detected by the input detecting portion; and
a display change controlling function for changing candidate items other than the selection item and displaying thereof when the selection item is being selected for a predetermined time or more, by the item selecting function.
